(19) United States
(12) Patent Application Publication
(10) Pub. No.: US 2007/0008130 A1
(43) Pub. Date: Jan. 11, 2007

(54) Telecommunications device using RFID data for device function execution

(75) Inventor: Peter Ashwood Smith, Hull (CA)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: Nortel Networks Limited, St. Laurent (CA)

(21) Appl. No.: 11/157,348

(22) Filed: Jun. 21, 2005

(51) Int. Cl. G08B 13/14

(52) U.S. Cl. 340/572.1

(57) ABSTRACT

A telecommunications device and method of executing a telecommunications device function using data stored in a radio frequency identification (RFID) tag are presented. The telecommunications device is positioned near the RFID tag and a device function is selected. An interrogation signal is transmitted from the telecommunications device to the RFID tag. In response, the RFID tag broadcasts stored data. The device function is executed using at least a portion of the broadcast data. The device function can be, for example, the initiation of a communications session with another telecommunications device. In another example, the device function includes storing at least a portion of the broadcast data in a memory module and associating the stored broadcast data with a user reference for later retrieval.

### FIELD OF THE INVENTION

The invention relates generally to a telecommunications device. More particularly, the invention relates to a telecommunications device for executing device functions using data stored in radio frequency identification tags.

### BACKGROUND OF THE INVENTION

Conventional telephones require users to enter a telephone number using a keypad or similar input device. Each digit in the telephone number must be entered in the correct order. This process can take 5 to 10 seconds or more before the keystrokes are completed and a call is initiated, depending on the complexity of the telephone number. In addition, a user may require repeated reference to a written or printed telephone number while entering the digits. If a user incorrectly enters one or more digits, the desired telephone is not reached. Instead, the user may call an unknown teach or receive a message stating that the number cannot be dialed as entered. The user then has to terminate the incorrect attempt and “re-dial” the number.

Commercial advertisers frequently provide printed advertisements to potential customers using mail or other distribution methods. The advertisement material can be a brochure, pamphlet or other printed document. In some instances, the advertisement material can be included in a publication such as a newspaper or a magazine. Alternatively, the advertisement can be printed in a visible location on an item such as a refrigerator magnet. The advertisements often include telephone numbers for potential customers to call to obtain product information, place orders and ask questions. Due to the effort required to make a telephone call as described above, a potential customer receiving such advertisements may decline to pursue the advertised product or service.

Printed advertisements can also include uniform resource locators (URLs) to enable potential customers having access to a personal computer (PC), a browser enabled personal digital assistant (PDA), a browser enabled telephone and the like to visit the advertiser's website to place orders, make inquiries, and view products and service listings. Users wishing to visit the advertiser's website are required to enter a keystroke for each character in the URL in proper order. An incorrectly entered URL can result in an error message stating that the web page cannot be displayed or can result in the display of a different web page. Thus, if the advertisement is not sufficiently compelling or if the user is not highly motivated to learn more, the user may reject the opportunity to view the website.

What is needed is a method for a user to quickly and easily establish a communications session while avoiding the disadvantages described above. The present invention satisfies this need and provides additional advantages.

### SUMMARY OF THE INVENTION

In one aspect, the invention features a method for executing a function of a telecommunications device using data stored in a radio frequency identification (RFID) tag. One of a plurality of device functions is selected and, in response, an interrogation signal is transmitted from the telecommunications device to the RFID tag. Data are broadcast from the RFID tag in response to the interrogation signal. The selected device function is executed using at least a portion of the broadcast data. In one embodiment the broadcast data includes a resource locator and the selected function includes initiating a communications session with a telecommunications device associated with the resource locator. In another embodiment the selected function includes storing at least a portion of the broadcast data in a memory module and associating the stored broadcast data with a user reference. The stored broadcast data includes data for initiating a communications session with another telecommunications device and the user reference identifies the other telecommunications device.

In another aspect, the invention features a telecommunications device for executing a device function using data broadcast by an RFID tag. The telecommunications device includes a telecommunications module for communicating with a remote telecommunications device, a trigger mechanism to generate a signal indicating a user request to execute the device function, and an RFID reader in communication with the trigger mechanism. The RFID reader is adapted to transmit an interrogation signal in response to the signal and to receive data broadcast from the RFID tag in response to the interrogation signal. The telecommunications device also includes a processor in communication with the telecommunications module, the trigger mechanism and the RFID reader, and a data operations module in communication with the processor. The data operations module executes the device function using at least a portion of the data broadcast from the RFID tag.

In yet another aspect, the invention features a telecommunications device for executing a device function using data broadcast by an RFID tag. The telecommunications device includes means for selecting a device function to be executed, means for transmitting an interrogation signal to the RFID tag responsive to the means for selecting, means for receiving broadcast data from the RFID tag, and means for executing the selected device function using at least a portion of the received broadcast data.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a block diagram of an RFID tag and an embodiment of a telecommunications device for executing a device function using data stored in the RFID tag in accordance with the invention.

FIG. 2 is a flowchart representation of an embodiment of a method for executing a telecommunications device function using data stored in an RFID tag in accordance with the invention.

FIG. 3 is a functional block diagram of a cell phone for executing a device function using data stored in an RFID tag according to an embodiment of the invention.

FIG. 4 is a functional block diagram of a cell phone for executing a device function using data stored in an RFID tag according to another embodiment of the invention.

FIG. 5 is a functional block diagram of a computer keyboard for executing a device function using data stored in an RFID tag according to an embodiment of the invention.

FIG. 6 is a functional block diagram of a mouse and computer for executing a device function using data stored in an RFID tag according to an embodiment of the invention.

### DETAILED DESCRIPTION

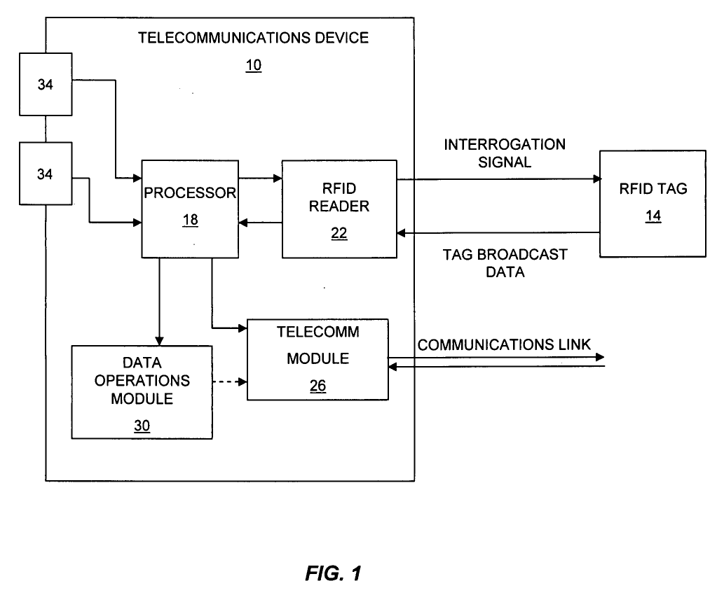

Referring to FIG. 1, the present invention relates to a telecommunications device 10 for executing a device function using data broadcast by a radio frequency identification (RFID) tag 14. The telecommunications device 10 can be a landline telephone handset, cordless phone, cell phone or wireless phone, voice over internet protocol (VOIP) phone, personal digital assistant (PDA) or other device communicating according to a variety of wireless standards (e.g., IEEE 802.11 standards), personal computer (PC), and the like.

The illustrated telecommunications device 10 includes a processor 18 in communication with each of an RFID reader 22, telecommunications module 26, data operations module 30 and multiple trigger mechanisms 34. In one embodiment, the RFID reader is a type 1 RFID reader capable of powering a type 1 RFID tag and reading data broadcast by the RFID tag. The telecommunications module 26 includes circuitry and components for transmitting analog or digital information over a communications link to one or more remote telecommunications devices. The communications link can be part of a communications network such as a local area network (LAN), an intranet, the Internet, cellular phone network, landline phone network, or other form of digital or analog communications network or combination thereof providing a link between telecommunications devices. In one embodiment, the data operations module 30 is configured for communication with the telecommunications module 26. Each trigger mechanism 34 can be a button, keypad or the like that causes a change in a signal level (e.g., voltage) of a respective trigger signal when pressed. Alternatively, each trigger mechanism can be voice-activated so that the signal level changes in response to a recognized verbal command.

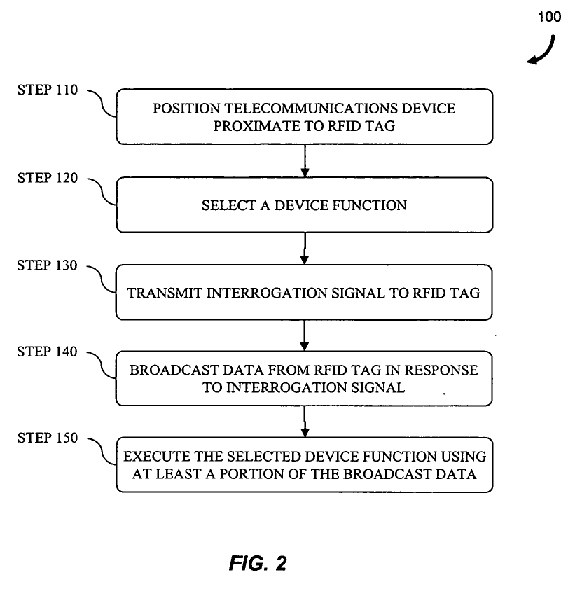

FIG. 2 is a flowchart representation of a method 100 for executing a function of a telecommunications device using data stored in an RFID tag. The device function can be, for example, the initiation of a communications session using a resource locator that identifies and locates a telecommunications device on a network. Such device functions include the dialing of a telephone number stored in the RFID tag or the loading of a web page associated with a uniform resource locator (URL) stored in the RFID tag. In other examples, the device function includes reading and saving in a memory module of the telecommunications device a resource locator (e.g., telephone number or URL) that is stored in the RFID tag along with a user reference such as a short form name.

Referring to FIGS. 1 and 2, a user positions (step 110) the telecommunications device 10 proximate to the RFID tag 14. The user selects (step 120) one of the device functions of the telecommunications device 10 by activating a corresponding one of the trigger mechanisms 34. In response to the function selection, a radio frequency (RF) interrogation signal is generated by the RFID reader 22 and transmitted (step 130) from the telecommunications device 10 to the RFID tag 14. The RFID tag 14 responds by broadcasting (step 140) stored tag data. The RFID reader 14 receives the broadcast data and provides the data to the processor 18. The data operations module 30 executes (step 150) the selected device function using broadcast data and instructions received from the processor 18. In some embodiments, the processor 18 passes only a portion of the broadcast data and may use one or more portions of the broadcast data for presentation on a telecommunications device display. In other embodiments, the processor 18 performs error detection or verifies that the received broadcast data comply with the expected data format for the selected function before passing at least a portion of the broadcast data to the operations module 30. The operations module 30 executes the device function using the broadcast data provided by the processor 18.

To call a telephone number stored in the RFID tag 14, the user positions the telecommunications device 10 near the RFID tag 14 and initiates the call using a single keystroke. Typically, the effort required by the user is completed in one or two seconds. A similar effort is required to request loading of a web page on a browser enabled telecommunications device based on a URL stored in the RFID tag 14. Consequently, a recipient of a printed advertisement having an embedded RFID tag storing a telephone number or URL is more likely to pursue product information, place an order, make an inquiry or otherwise “follow up” on the advertisement than a recipient of a conventional printed advertisement that simply lists the telephone number or URL.

The low unit cost of passive RFID tags makes them desirable for distributing a range of information. For example, business contact information, such as the name, address, telephone number, email address and other information for a business person can be inexpensively provided in RFID tags that are embedded in business cards or similarly distributed items. In addition, printed advertisements, sales brochures, product information pamphlets, and the like can include inexpensive RFID tags to facilitate the distribution of information to potential customers.

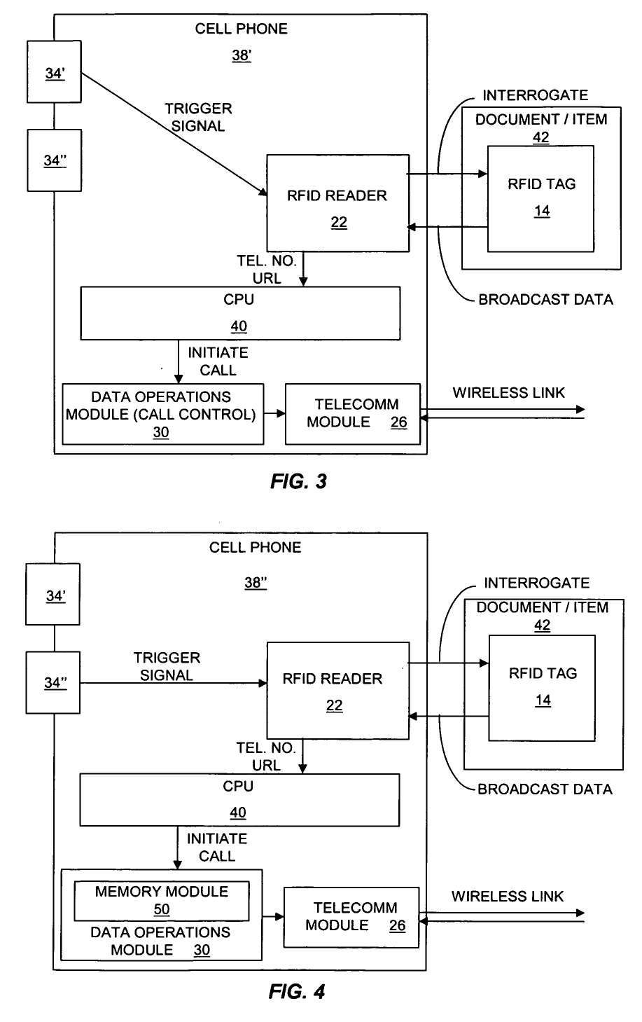

FIG. 3 is a functional depiction of a cell phone 38′ configured to use data stored in an RFID tag 14 according to an embodiment of the invention. The cell phone 38′ includes an RFID reader 22, telecommunications module 26, data operations module 30 and central processing unit (CPU) 40. To make a call to a telephone number stored on an RFID tag 14, a user positions the cell phone 38′ near the document or item 42 containing the RFID tag 14 containing the RFID tag 14 and presses a button or keypad 34′ associated with a “scan and call” device function. The cell phone 38′ and RFID tag 14 operate cooperatively to automatically initiate a call over a wireless link to a telecommunications device associated with the stored telephone number.

In operation, when the user presses the keypad 34′, the RFID reader 22 is activated by the trigger signal and responds by transmitting an interrogation signal to the RFID tag 14. In response to the interrogation signal, the RFID tag 14 is activated (i.e., powered) and broadcasts stored data that includes the telephone number. Optionally, the broadcast data include a user reference (e.g., name) associated with the telephone number that can be presented to the user on a device display.

The broadcast data are received by the RFID reader 22 and written to a block of memory (not shown) which may be part of the CPU 40 or can be a separate memory module. The CPU 40 decodes the data and verifies that the received data include a logically correct telephone number before passing the telephone number to the data operations module 30 which includes a call control module to initiate the call.

In another embodiment, the cell phone 38′ is browser enabled and the user depresses another keypad 34″ to execute a “scan and load URL” device function to automatically retrieve a web page associated with a URL stored in the RFID tag 14. In this embodiment, the broadcast data include the URL. The CPU 40 decodes the data and verifies that the received data include a logically correct URL before passing the URL to the data operations module 30 to initiate communications with a server hosting the desired web page. It should be recognized that PDAs and other browser enabled devices can be similarly configured to provide the “scan and load URL” device function in accordance with the invention.

In other embodiments, other types of resource locators are used in place of the telephone number or URL to implement the scan and call or scan and load device functions. These other resource locators identify and locate various types of telecommunication devices on a variety of communications networks.

FIG. 4 is a functional depiction of a cell phone 38″ configured to use data stored in an RFID tag 14 according to another embodiment of the invention. The cell phone 38″ includes an RFID reader 22, telecommunications module 26, data operations module 30 and CPU 40. In this embodiment, the data operations module 30 includes a memory module 50 configured to maintain a database of telephone numbers, URLs or both. To retrieve a telephone number, URL or other information from the RFID tag 14, a user positions the cell phone 38″ near the RFID tag 14 and presses a keypad 34″ associated with a “scan and save” device function. The cell phone 38″ and RFID tag 14 operate cooperatively to write the telephone number, URL or other information to the memory module 50.

Execution of the scan and save function is similar to the execution of the scan and call function described for the cell phone 38′ of FIG. 3; however, the broadcast data can also include a user reference such as a name associated with the telephone number, a “favorites” name associated with the URL or a descriptive label associated with the other information. The telephone number, URL or other information written to the memory module 50 can be retrieved using the user reference at a later time to make a call, load a web page or display the other information to the user, respectively. Optionally, the user can replace the user reference with a different user reference according to the user's preference. For example, a favorites name can be modified for easier recognition of the associated URL by the user.

Although the illustration embodiments of FIGS. 3 and 4 are limited to a cell phone, it should be recognized that other telephone enabled and browser enabled telecommunications devices can be similarly configured to provide one or more of the “scan and call”, “scan and load URL” and “scan and save” device functions.

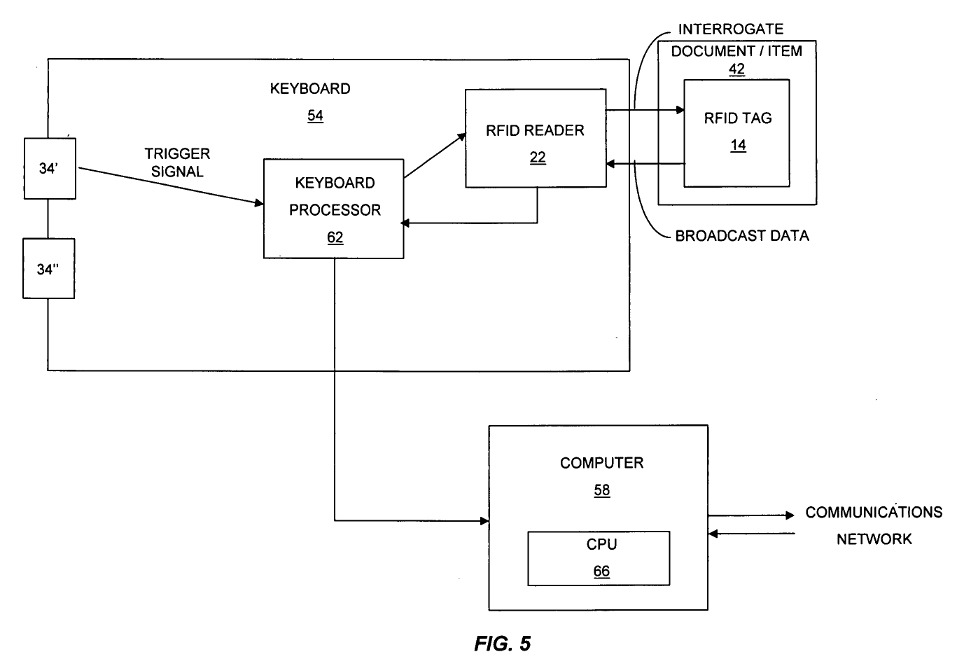

FIG. 5. shows a keyboard 54 which can read data from an RFID tag 14 and execute device functions using the data in accordance with an embodiment of the invention. The illustrated keyboard 54 is used as an input device for a computer 58. The keyboard 54 includes an RFID reader 22, trigger mechanisms 34 and a keyboard processor 62. The trigger mechanisms 34 can be dedicated buttons located separate from the keys on the top surface of the keyboard 54. Alternatively, the trigger mechanisms 34 can be dedicated keypads such as a function and control keypad (e.g., “F-key”) or a predefined sequence of keypads.

To execute a device function, a user holds a document or item 42 containing the RFID tag 14 close to the region of the keyboard 54 where the RFID reader 14 is located. The user then presses a button, keypad or sequence of keypads associated with the desired device function to activate the RFID reader 22. In response, the RFID reader 22 transmits an interrogation signal which initiates a broadcast of data from the RFID tag 14. The received broadcast data are provided to a CPU 66 in the computer 58 for data processing (e.g., telephone number verification). In one embodiment, the keyboard processor 62 performs data operations before providing at least a portion of the received broadcast data to the computer 58. In another embodiment, the keyboard 54 includes a separate processor or CPU to perform the data operations.

Various device functions such as scan and call, scan and load URL, and scan and save as described above can be executed using the keyboard 54. In one embodiment, the scan and call device function is used to initiate a VOIP communications session.

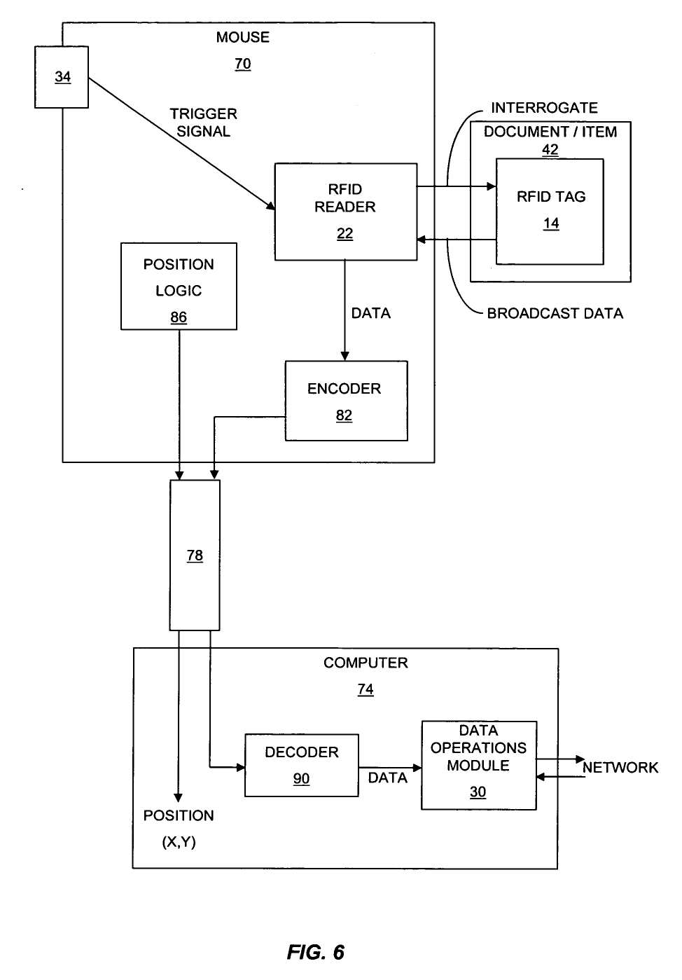

FIG. 6 shows a mouse 70 and computer 74 for reading data from an RFID tag 14 and executing a device function using the data. The mouse 70 can be of any general type including, for example, an optomechanical mouse such as a mouse utilizing dual rollers, internal optical source and encoder disks, or an optical mouse employing a sensor array, digital signal processor (DSP) and optical source such as a light emitting diode (LED) or a laser for external illumination. The mouse 70 communicates with the computer 74 through a data link 78. The link 78 permits data transfer based, for example, on a universal serial bus (USB) protocol or a wireless protocol such as Bluetooth® or other RF connectivity standard.

Although the illustrated embodiment depicts a mouse, it should be recognized that other user interface pointing devices can be configured to read RFID data and execute device functions in accordance with the principles of the invention.

To read the data stored in an RFID tag 14, a user positions the mouse near to or over a portion of a document or item 42 that includes the RFID tag 14. The user initiates a device function by pressing a button 34 on the mouse 70. After detecting an interrogation signal, the RFID tag 14 broadcasts stored data and the RFID reader 22 receives the broadcast data. At least a portion of the received broadcast data are provided to an encoder 82 which encodes the data in a format compatible with the link protocol. Position data describing the two-dimensional location of the mouse 70 defined with respect to a coordinate system (e.g., coordinates of a graphical user interface (GUI)) are generated by a position logic module 86. The encoded data and position data are transmitted across the data link 78 to the computer 74 where the encoded data are decoded by a decoder 90 and forwarded to a data operations module 30. Optionally, the position data are also provided to the data operations module 30.

The mouse 70 and computer 74 can be used to execute the scan and call, scan and load URL, and scan and save device functions described above. As illustrated, telephone communications can be implemented through a network using VOIP. In another embodiment, the computer 74 is configured for communication sessions with other types of telecommunication devices. For example, the computer can include a modem for landline or wireless communications.

In other embodiments some or all of the received broadcast data are presented to the user on a monitor display. For example, the telephone number and user reference of the current session can be displayed. Optionally, the monitor display can be used to present a GUI to the user. The GUI can include buttons to act as trigger mechanisms associated with the available device functions. The user can point and click on the appropriate button to select the desired device function.

While the invention has been shown and described with reference to specific embodiments, it should be understood by those skilled in the art that various changes in form and detail may be made therein without departing from the spirit and scope of the invention.

What is claimed is:

1. A method for executing a function of a telecommunications device using data stored in a radio frequency identification (RFID) tag, the method comprising:
selecting one of a plurality of functions of the telecommunications device;
transmitting an interrogation signal from the telecommunications device to the RFID tag in response to the selection of the function;
broadcasting data from the RFID tag in response to the interrogation signal; and
executing the selected function of the telecommunications device using at least a portion of the broadcast data.

2. The method of claim 1 further comprising positioning the telecommunications device proximate to the RFID tag prior to selecting one of the functions.

3. The method of claim 1 wherein the broadcast data comprise a resource locator and the selected function comprises initiating a communications session with a telecommunications device associated with the resource locator.

4. The method of claim 3 wherein the communications session comprises a telephone communications session and the resource locator is a telephone number.

5. The method of claim 3 wherein the communications session comprises an Internet communications session and the resource locator is a uniform resource locator.

6. The method of claim 3 wherein the communications session comprises a voice over Internet protocol communications session and the resource locator is a telephone number.

7. The method of claim 1 wherein the selected function comprises:
storing at least a portion of the broadcast data in a memory module; and
associating the stored broadcast data with a user reference.

8. The method of claim 1 wherein the selected function comprises:
storing at least a portion of the broadcast data in a memory module, the stored broadcast data comprising data for initiating a communications session with another telecommunications device; and
associating the stored broadcast data with a user reference identifying the another telecommunications device.

9. The method of claim 1 wherein the selected function comprises:
storing at least a portion of the broadcast data in a memory module, the stored broadcast data comprising a resource locator; and
associating the stored broadcast data with a user reference identifying the resource locator.

10. A telecommunications device for executing a device function using data broadcast by a radio frequency identification (RFID) tag comprising:
a telecommunications module for communicating with a remote telecommunications device;
a trigger mechanism to generate a signal indicating a user request to execute the device function;
an RFID reader in communication with the trigger mechanism, the RFID reader adapted to transmit an interrogation signal in response to the signal and to receive data broadcast from the RFID tag in response to the interrogation signal;
a processor in communication with the telecommunications module, the trigger mechanism and the RFID reader; and
a data operations module in communication with the processor to execute the device function using at least a portion of the data broadcast from the RFID tag.

11. The telecommunications device of claim 10 wherein the data operations module comprises a call control module in communications with the telecommunications module, the call control module initiating a communications session with the remote telecommunications device in response to the at least a portion of the data broadcast from the RFID tag.

12. The telecommunications device of claim 10 wherein the RFID reader is in communication with the trigger mechanism through the processor.

13. The telecommunications device of claim 10 wherein the data operations module comprises a memory module to store the at least a portion of the data broadcast from the RFID tag, the at least a portion of the data comprising information for initiating a communications session with another telecommunications device and being associated with a user reference identifying the another telecommunications device to a user.

14. The telecommunications device of claim 10 wherein the data operations module comprises a memory module to store the at least a portion of the data broadcast from the RFID tag, the at least a portion of the data comprising a resource locator for initiating communications with a remote resource and being associated with a user reference identifying the resource locator to a user.

15. The telecommunications device of claim 10 wherein the RFID reader is embedded in a telephone.

16. The telecommunications device of claim 10 wherein the RFID reader is embedded in a personal digital assistant.

17. A telecommunications device for executing a device function using data broadcast by a radio frequency identification (RFID) tag comprising:
means for selecting a device function to be executed;
means for transmitting an interrogation signal to the RFID tag responsive to the means for selecting;
means for receiving broadcast data from the RFID tag; and
means for executing the selected device function using at least a portion of the received broadcast data.

18. The telecommunications device of claim 17 wherein the means for executing the selected device function comprises:
means for storing the at least a portion of the broadcast data in a memory module; and
means for associating the stored broadcast data with a user reference.

19. The telecommunications device of claim 17 wherein the means for executing the selected device function comprises:
means for storing the at least a portion of the broadcast data in a memory module, the stored broadcast data comprising data for initiating a communications session with another telecommunications device; and
means for associating the stored broadcast data with a user reference identifying the another telecommunications device.

20. The telecommunications device of claim 17 wherein the means for executing the selected device function comprises:
means for storing at least a portion of the broadcast data in a memory module, the stored broadcast data comprising a resource locator; and
means for associating the stored broadcast data with a user reference identifying the resource locator.
